(19) United States
(12) Patent Application Publication
(10) Pub. No.: US 2009/0215375 A1
(43) Pub. Date: Aug. 27, 2009

(54) Fan Assemblies, Mechanical Draft Systems and Methods

(75) Inventor: Steen Hagensen, Roswell, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: GREENVEX, Roswell, GA (US)

(21) Appl. No.: 12/434,850

(22) Filed: May 4, 2009

Related U.S. Application Data
(63) Continuation-in-part of application No. 10/712,516, filed on Nov. 13, 2003, now Pat. No. 7,275,533.
(60) Provisional application No. 60/453,086, filed on Mar. 6, 2003.

(51) Int. Cl. F23J 11/00; F24B 1/189; G05B 15/00; F24B 1/18; F24B 1/187; F24F 13/10; F04D 29/58

(52) U.S. Cl. 454/42; 126/521; 700/275; 126/512; 126/502; 454/358; 416/95

(57) ABSTRACT

Fan assemblies, mechanical draft systems and methods are provided. In this regard, a representative mechanical draft system for use with multiple appliances includes: a chimney operative to direct combustion products from multiple appliances; a chimney fan operative to draw combustion products from the chimney; and a controller operative to adjust an operating speed of the chimney fan such that, responsive to a change in pressure in the chimney, the controller adjusts the operating speed of the chimney fan to maintain a desired pressure in the chimney.

### CROSS-REFERENCE TO RELATED APPLICATIONS

This application is a continuation-in-part application of co-pending U.S. patent application Ser. No. 10/712,516, filed Nov. 13, 2003, and entitled “Pressure Controller for a Mechanical Draft System,” which claims the benefit of U.S. provisional application No. 60/453,086, filed on Mar. 6, 2003, and entitled “Systems and Methods Involving Modulating Pressure Controls,” both of which are incorporated by reference in their entireties into the present disclosure.

### TECHNICAL FIELD

The present disclosure generally relates to exhaust systems or mechanical draft systems. More particularly, the disclosure relates to controllers for exhaust systems or mechanical draft systems.

### DESCRIPTION OF THE RELATED ART

The boiler rooms, or mechanical rooms, of a building can house a number of combustion appliances, such as water heaters, furnaces, and boilers, which are used for heating purposes within the building. Within conventional mechanical rooms, many control devices are used for controlling the different components therein. For example, each individual furnace or boiler may be connected to a respective control device that controls the flow of combustion air and exhaust air through that furnace alone. The control device may also affect a furnace shut down procedure during unstable conditions. Mechanical rooms can also house one or more control devices for controlling a ventilating blower and one or more control devices for controlling an induction draft blower. With the large number of control devices in the mechanical room providing various functions, coordination among the various controllers can be quite complex. Furthermore, in this regard, components and functions can be unnecessarily duplicated.

It has been contemplated to coordinate the control of the ventilating blower and induction draft blower to regulate the air flow through the mechanical room. However, until now, greater processor functionality has yet to be achieved for simplifying the installation and control of mechanical draft systems.

During installation of a conventional mechanical draft system, very little feedback is provided to the installers to indicate whether or not the components are properly connected in the system. Because of this deficiency, correcting any problems after installation becomes much more difficult. It would be beneficial to the installers to receive positive feedback to determine whether or not corrections should be made during installation.

One concern that has been identified regarding conventional mechanical draft systems is their lack of intelligent processing functionality for controlling furnaces or boilers during less than optimal conditions. In those systems, furnaces or boilers are typically shut down and prevented from operating until an error or problem in the system is corrected. This all-or-nothing approach can result in a number of machines sitting idly during times of great need. Therefore, a void exists in the prior art for allowing a system to operate in a low output state during less than optimal conditions and to operate in such conditions without compromising safety and efficiency.

Conventional mechanical draft systems may also present challenging installation and/or reconfiguration scenarios. For example, some mechanical rooms may be large, requiring long distances of cabling be run between a controller and related equipment such as, but not limited to, the appliances, sensors, actuators, etc. Additionally, such systems may be installed after a mechanical room has already been in operation for a number of years. Thus, physical obstructions may exist requiring cabling between the controller and related equipment be run for even longer distances or in inconvenient locations. Additionally, as system objectives and/or demands change, appliances and/or related equipment may be added to the system, requiring additional cabling. Therefore a need exists for a system having improved installation and/or reconfiguration requirements to allow for the communication between the controller and related equipment without the need for running long distances of wire between the two.

Another concern with conventional mechanical draft systems is the lack of remote access to the pressure controller. Specifically, conventional controllers are located in areas that are easily accessible by support staff such that the controllers may be physically accessed for the purpose of programming and troubleshooting. However, a need exists for providing remote connectivity to the controller of a mechanical draft system such that the controllers may be installed in a location without regard to continuous physical access. Such remote connectivity may also enable a number of troubleshooting and notification capabilities not previously provided by stand-alone mechanical draft systems.

Yet another problem not addressed by conventional mechanical draft systems is the lack of programmable appliance sequencing. For example, conventional draft systems are not programmable to prioritize the use of specific appliances to meet a demand based on predefined, and programmable, conditions.

### SUMMARY

Mechanical draft systems and related methods are provided. In this regard, an exemplary embodiment of a mechanical draft system comprises: a chimney operative to direct combustion products; a chimney fan operative to draw combustion products from the chimney; a first fireplace operative to provide combustion products to the chimney; a second fireplace operative to provide combustion products to the chimney; and a controller operative to adjust an operating speed of the chimney fan such that, responsive to a change in pressure in the chimney, the controller adjusts the operating speed of the chimney fan to maintain a desired pressure in the chimney.

An exemplary embodiment of a mechanical draft system for use with multiple appliances comprises: a chimney operative to direct combustion products from multiple appliances; a chimney fan operative to draw combustion products from the chimney; and a controller operative to adjust an operating speed of the chimney fan such that, responsive to a change in pressure in the chimney, the controller adjusts the operating speed of the chimney fan to maintain a desired pressure in the chimney.

An exemplary embodiment of a method for controlling multiple appliances comprises: providing multiple appliances, each of which is operative to facilitate independent, locally controlled ignition; venting combustion products of the multiple appliances using a single chimney; and controlling pressure in the chimney with a single chimney fan.

An exemplary embodiment of an exhaust fan assembly comprises: a housing defining a chamber and having opposing openings, the opposing openings having a centerline extending therebetween, a first of the openings being operative to intake a flow of gases, a second of the openings being operative to exhaust the flow of gases from the chamber; and a centrifugal fan having a motor and an impeller, the motor being mounted external to the housing, the impeller being positioned within the chamber, a rotational axis of the impeller being inclined with respect to the centerline extending between the openings of the housing.

Other systems, methods, features, and advantages of the present disclosure will be apparent to one having skill in the art upon examination of the following drawings and detailed description. It is intended that all such additional systems, methods, features, and advantages be included within this description and protected by the accompanying claims.

### BRIEF DESCRIPTION OF THE DRAWINGS

Many aspects of the embodiments disclosed herein can be better understood with reference to the following drawings. The components in the drawings are not necessarily to scale, emphasis instead being placed upon clearly illustrating the principles of the present disclosure. Like reference numerals designate corresponding parts throughout the several views.

FIG. 1 is a partial block diagram illustrating an embodiment of a mechanical draft system.

FIG. 2A is a block diagram of an embodiment of the pressure and combustion controller shown in FIG. 1.

FIG. 2B depicts a block diagram of an exemplary auxiliary computing device capable of providing a number of supplemental services to the pressure and combustion controller of FIG. 2A.

FIGS. 3A and 3B are front and bottom views illustrating an embodiment of a housing for a pressure and combustion controller.

FIG. 4 is a flow chart of an embodiment of a set-up routine for a mechanical draft system.

FIG. 5 is a flow chart of an embodiment of a fan-rotation-check routine for a mechanical draft system.

FIG. 6 is a flow chart of an embodiment of a routine for monitoring and controlling air pressure in a mechanical draft system.

FIG. 7 is a flow chart of an embodiment of a priority sub-routine for a mechanical draft system.

FIG. 8 is a flow chart of an embodiment of a routine for running a bearing cycle in a mechanical draft system.

FIG. 9 is a flow chart of an embodiment of a routine for sequencing a number of appliances using a mechanical draft system.

FIG. 10 depicts another embodiment of a mechanical draft system.

FIG. 11 depicts an embodiment of a fan assembly installed in a vertical orientation.

FIG. 12 depicts the fan assembly of FIG. 11 installed in a horizontal orientation.

FIG. 13 is a partially-exploded view of the embodiment of FIGS. 11 and 12.

FIG. 14 is a partial block diagram illustrating an embodiment of a mechanical draft system incorporating an embodiment of a heat recovery unit.

### DETAILED DESCRIPTION

Fan assemblies, mechanical draft systems and methods are provided. In some embodiments, combustion air is drawn into a mechanical room and supplied to combustion or heating devices and air exhausted from the combustion or heating devices is vented from the mechanical room into the atmosphere. Some embodiments of the controllers are capable of controlling the on/off state and speed of intake fans and exhaust fans and can also control any number of appliances, such as furnaces or boilers, within the system. The unitary controllers disclosed herein may be configured using microprocessor elements or other suitable electrical components for providing greater functionality than conventional exhaust system controllers. Also, the controllers can be programmed in the field and reprogrammed as desired allowing greater flexibility.

The controllers can be initialized during the installation or set-up of the mechanical draft system. The initialization process involves entering information about the equipment and determining whether the equipment may require additional components to run properly. The controllers may provide installation instructions for the additional components as needed. The initialization process also involves setting maximum and minimum fan speeds and setting pre-purge and post-purge parameters. Initialization also involves determining the number of appliances connected in the system and setting a priority list of the appliances for use when adequate draft cannot be maintained with all appliances running. Also established during installation or set-up is the proper positions of adjustable dampers or baffles for optimal air flow from the individual appliances. The position of a modulating damper is also adjusted to control air flow from cumulative appliances. Moreover, a fan-rotation-check procedure may be run to determine whether or not the fans are rotating in the correct direction.

After set-up and during system operation, some embodiments of the controllers disclosed herein are capable of carrying out a process of operating the fans during long periods of inactivity. This process, referred to herein as a “bearing cycle,” allows the fans to run for a short amount of time, such as during off-season times, to exercise the bearing. Reference is now made to the drawings illustrating the embodiments of the mechanical draft system, pressure and combustion controllers, and methods of operation.

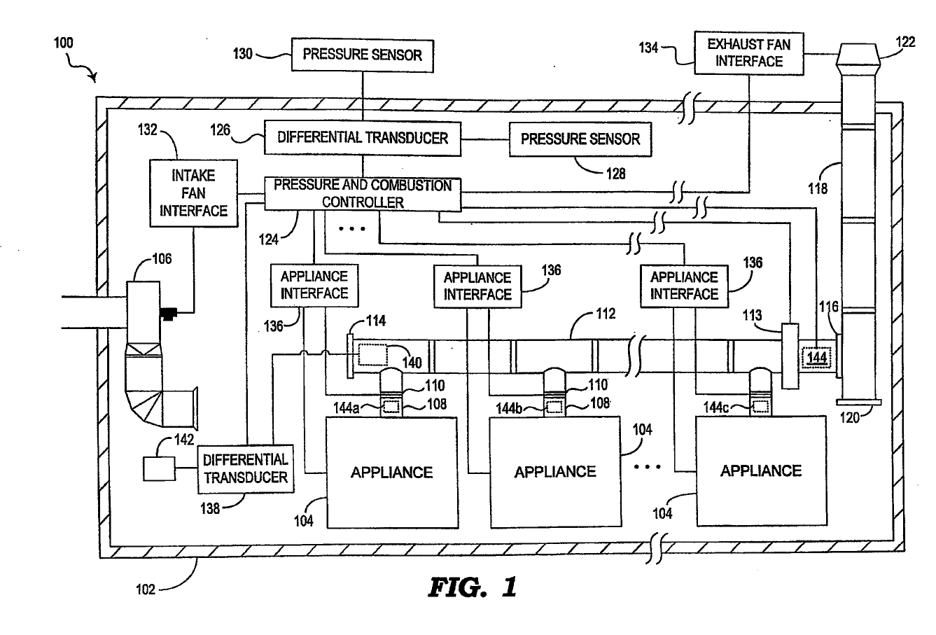

FIG. 1 shows an embodiment of a mechanical draft system 100, having components located both inside and outside of a mechanical room 102. The mechanical room 102 may be a boiler room, laundry facility, or other room or enclosed area where a plurality of electrical or mechanical heat generating machines or appliances 104 are used. The appliances 104 may include boilers, modulating boilers, furnaces, water heaters, gas or electric laundry dryers, wood-burning devices, heating devices, etc.

An intake fan 106 draws air from outside the mechanical room 102 into the mechanical room 102 to provide combustible air for the appliances 104. The intake fan 106 may be programmed to increase its speed of rotation when the appliances are fired in order to provide sufficient combustion air. It should be noted that the intake fan 106 may include any well-known type of fan, such as a single-phase fan or three-phase fan. The intake fan 106 cooperates with input ducts that penetrate the walls or ceiling of the mechanical room 102 and lead outside the building. The intake fan 106 and corresponding ducts may have any suitable configuration and may be supported or directed in any suitable manner. The ducts at the output of the intake fan 106 may lead directly to the appliances 104 in a direct venting configuration. Also, the ducts, if desired, may include diffusers leading to the interior of the mechanical room 102.

The appliances 104 draw air from inside the mechanical room 102 or directly from the intake fan 106 for combustion with a gas-based, oil-based, or wood-based fuel. Exhaust from the appliances 104, in the form of heated gases, smoke, or the like, travels through an air exhaust duct 108, which contains an adjustable baffle or damper 110 for controlling the draft into ducts 112. The damper 110, which may be a modulating damper, may have an open position for allowing exhaust to pass through virtually unhindered, a closed position for preventing exhaust from passing, and one or more intermediate positions for balancing the air flow with respect to the exhaust from other appliances 104 in the system.

Air exhausted into the ducts 112 travels through a modulating damper 113, which controls and maintains draft for single or multiple appliances 104. The modulating damper 113 may include multiple blades for controlling the draft. The modulating damper 113 can be used within ducts 112 or within any other type of vent or stack. The modulating damper 113 may be attached to one or more actuators, controllers, pressure sensors, draft probes, and over-pressure safety switches for controlling and maintaining draft. The modulating damper 113 is used when the mechanical draft system 100 generates more draft than the appliances 104 can handle. By modulating the position of the modulating damper 113, a constant draft for the appliances 104 can be maintained.

Upon a call for heat, the modulating damper 113 can be opened completely during a predetermined pre-purge time. When one or more of the appliances 104 are fired and the draft reaches a predetermined draft set-point, the modulating damper 113 modulates to maintain a constant draft. This sequence is repeated every time another of the appliances 104 is fired. When one or more appliances 104 shut down, the modulating damper 113 closes slightly while maintaining the predetermined draft set-point. When the last appliance is shut down, the modulating damper 113 stays open in accordance with any post-purge settings.

The mechanical draft system 100 includes over-pressure protection for a situation where excessive pressure builds up between the outlet of the appliances 104 and the modulating damper 113. When this over-pressure situation occurs, one or more of the appliances 104 are shut down and the modulating damper 113 is opened completely to relieve the pressure within the ducts 112.

The ducts 112 include an end 114 that may include a closed header or an opened barometric damper to balance the system. Exhaust travels through the ducts 112 to another end 116 that is open to a vertical stack or chimney 118. The chimney 118, which may be closed at one end 120, leads the exhaust outside the mechanical room 102 through an exhaust fan 122 at the other end. The exhaust fan 122 draws the exhaust from inside the ducts 112 and chimney 118 into the atmosphere.

The mechanical draft system 100 further includes a pressure and combustion controller 124 for maintaining an acceptable air pressure inside the mechanical room 102. The pressure and combustion controller 124 controls the speeds of the intake fan 106 and exhaust fan 122 in order to provide an adequate draft through the mechanical draft system 100. By regulating the supply of air to the appliances 104, the energy efficiency of the appliances 104 is greatly improved. Maintaining an equalized air pressure between the atmosphere and the interior of the mechanical room 102 further avoids dangerous operating conditions.

According to some embodiments, the pressure and combustion controller 124 monitors the differential pressure that is calculated from the difference in air pressure between the inside of the mechanical room 102 and the atmosphere. If a positive differential pressure is calculated, indicating excess air pumped into the mechanical room 102 relative to the atmosphere, sometimes referred to as overdraft, then the pressure and combustion controller 124 slows down or shuts off the intake fan 106 and/or speeds up the exhaust fan 122 if possible. If a negative differential pressure is calculated based on a lack of adequate air inside the mechanical room 102 relative to the atmosphere, then the pressure and combustion controller 124 speeds up the intake fan 106 if possible and/or slows down or shuts off the exhaust fan 122. When a negative differential pressure exists, the pressure and combustion controller 124 may additionally adjust the dampers 110 or modulating damper 113 to more greatly restrict the exhaust from the appliances 104. These actions will serve to avoid overdraft, especially during times when the appliances are running at less than full capacity.

If the differential pressure exceeds a predetermined threshold, indicating an excessive difference between the pressure inside the mechanical room 102 relative to the atmosphere, then the pressure and combustion controller 124 shuts down the appliances 104. For instance, if the pressure in the mechanical room 102 is 40% above or below a normalized atmospheric pressure, representing a potentially dangerous situation, then the appliances 104 are shut down. The pressure and combustion controller 124 may additionally reset the appliances automatically when the differential pressure returns to an acceptable level, thereby avoiding lapses of service, which can result from the use of manual reset switches.

The pressure and combustion controller 124 of the present disclosure can be implemented in hardware, software, firmware, or a combination thereof. In the disclosed embodiments, the pressure and combustion controller 124 can be implemented in software or firmware that is stored in a memory and that is executed by a suitable instruction execution system. If implemented in hardware, as in an alternative embodiment, the pressure and combustion controller 124 can be implemented with any combination of the following technologies, which are all well known in the art: one or more discrete logic circuits having logic gates for implementing logic functions upon data signals, one or more application specific integrated circuits (ASICs) having appropriate logic gates, a programmable gate array (PGA), a field programmable gate array (FPGA), etc.

According to some embodiments, the pressure and combustion controller 124 receives a differential pressure signal from a differential transducer 126. The differential transducer 126 calculates the differential pressure based on a first pressure reading from inside the mechanical room 102 and a second pressure reading from outside the mechanical room 102, preferably from the atmosphere. The first pressure reading may be taken from an open port in the differential transducer 126 or may optionally be taken from a first pressure sensor 128. The first pressure sensor 128 may be attached to an interior wall of the mechanical room 102 or may be secured inside the ducts 112 or chimney 118. The second pressure reading may be taken from a second pressure sensor 130, preferably located on a roof top of the building.

According to some embodiments, a second differential transducer 138 provides pressure and combustion controller 124 with a differential pressure between the inside of the mechanical room 102 (e.g. with pressure sensor 142) and a second pressure inside of the chimney 122 and/or ducts 112 (e.g. with pressure sensor 140). A measurement of the differential in pressure between the mechanical room 102 and the ducts 112 and/or chimney 118 provides pressure and combustion controller 124 with yet another indication of the flow of air passing through chimney 122. The measurements provided by differential transducers 126 and 138 can be used independently, or together, by pressure and combustion controller 124 to control the proper draft through duct 112 and chimney 118 (e.g. through modulating the speed of fans and/or dampers).

According to some embodiments of mechanical draft system 100 can also use one or more oxygen sensors, sometimes known as lambda sensors, to monitor the oxygen level in the exhaust of appliances 104. Heating appliances operate on the basis of a stoichiometric combustion process, which is perfect combustion. Thus, a stoichiometric combustion process uses a perfect combination of fuel and oxygen with no other liquids or gases. However, in reality, perfect combustion is not generally possible because atmospheric air has only a certain amount of oxygen and atmospheric air contains other gases and liquids that are not used in the combustion process, but still become part of the products of combustion that are being exhausted via the duct 112 and chimney 118. However, oxygen sensors can be used to monitor the oxygen level in the air after the combustion process (e.g. the exhaust), and can send a signal to the controller when the oxygen level exceeds and/or falls below specified thresholds. Such thresholds will vary by the specific appliance and environmental conditions. Incorporating oxygen sensors into mechanical draft system 100 can provide not only proper draft, but can be used to accurately monitor and control the oxygen content in the exhausted flue gases. This allows the appliances 104 to operate as efficient as possible while minimizing harmful emissions.

For example, oxygen sensor 144 can be located in the chimney 118 and/or ducts 112 to monitor the oxygen level in the exhaust duct common to all of the appliances 104. However, in some embodiments, oxygen sensors 144a-144c can be placed in the exhaust ducts 108 of each appliance 104 in order to monitor the exhaust of each appliance 104 individually. Each of sensors 144a-144c are communicatively coupled to provide oxygen readings to pressure and combustion controller 124. Damper 110, which can be a modulating damper, can be installed in-line downstream of the exhaust flow from the oxygen sensors 144a-144c. Each interface of the damper 110 is also connected to the pressure and combustion controller 124.

In use, the pressure and combustion controller 124 can receive a signal (e.g. “call for heat”) from an appliance 104 thermostat or other switch or monitor. The pressure and combustion controller 124 can then cause the damper 110 in the respective appliance's exhaust duct 108 to open and can also activate the exhaust fan 122 (and intake fan 106, if installed and needed). The fan(s) can be set to reach a preset draft set point. When this draft set point is proven, the appliance 104 is released by the pressure and combustion controller 124. Once the appliance 104 fires, the pressure and combustion controller 124 can monitor the oxygen levels in the exhaust gas via the respective oxygen sensor 104a-104c. If the oxygen level is too high, pressure and combustion controller 124 controls damper 110 to move towards a more closed position until the proper oxygen level is reached. If the oxygen level is too low, pressure and combustion controller 124 controls damper 110 to move towards a more open position until the proper oxygen level is reached. The damper can regulate on predefined intervals, or continuously, to maintain the proper oxygen level.

Embodiments using oxygen sensors 144 and/or 144a-144c add the ability to control an appliance's combustion by measuring the oxygen level—rather than, or in conjunction with, the draft pressure. Thus, the exhaust fan 122 and/or the intake fan 106 combined with the modulating damper 110 can make the necessary fan speed and damper adjustments to maintain the specified oxygen content in the flue gases. According to some embodiments, if the oxygen level is outside a specified level by a preset threshold, the pressure and combustion controller 124 can provide an alarm signal and/or shut down one or more appliances 104.

Thus, regardless of the types of sensors installed, the pressure and combustion controller 124 ensures that a proper draft is maintained through the mechanical draft system 100 by transmitting signals to various components via interface devices. For example, an intake fan interface 132 is positioned between the pressure and combustion controller 124 and the intake fan 106. An exhaust fan interface 134 is positioned between the pressure and combustion controller 124 and the exhaust fan 122. Appliance interfaces 136 are positioned between the pressure and combustion controller 124 and each respective appliance 104.

The intake fan interface 132 and exhaust fan interface 134 may include a power source (not shown), such as a variable frequency drive (VFD), for supplying three phase power signals when the fans are three-phase fans. The intake fan interface 132 and exhaust fan interface 134 may also monitor characteristics of the fans and indicate various information to the pressure and combustion controller 124. For instance, the interfaces 132 and 134 may indicate to the pressure and combustion controller 124 the existence of the fans. If a fan does not exist on the intake or exhaust side, then the pressure and combustion controller 124 can bypass any control functions intended for the missing fan. The interfaces 132 and 134 may also indicate whether the fans are operating properly and if the fans are malfunctioning. The interfaces 132 and 134 also sense the speed of the respective fans and indicate the speeds to the pressure and combustion controller 124. Furthermore, the interfaces 132 and 134 receive control signals from the pressure and combustion controller 124 for adjusting the speeds of the respective fans.

The appliance interfaces 136 may contain a proven draft switch (not shown) which receives a signal from the pressure and combustion controller 124 to shut down the appliances when insufficient draft is detected. The appliance interfaces 136 may also receive signals from the pressure and combustion controller 124 to adjust the position of the dampers 110, thereby controlling the exhaust from individual appliances 104. The modulating damper 113 may optionally be configured to be controlled by the appliance interfaces 136. The appliance interfaces 136 may also transmit signals to the pressure and combustion controller 124 to indicate various information about the appliances 104 and dampers 110. For example, the appliance interfaces 136 may inform the pressure and combustion controller 124 of the presence of the respective appliances 104 so that the number of appliances 104 connected in the mechanical draft system 100 can be determined. The appliance interfaces 136 may also indicate whether or not the appliances 104 are currently running for monitoring periods of inactivity. The appliance interfaces 136 may also indicate the presence and position of the dampers 110.

The connections between pressure and combustion controller 124 and its associated input/output devices, such as differential transducer 126, pressure sensor 128, pressure sensor 130, intake fan interface 132, exhaust fan interface 134, and appliance interfaces 136 may be any wired or wireless connection. In addition to the pressure sensors, any other sensors located remote from pressure and combustion controller 124 (e.g. those determined useful for the purpose of data collection) may also be similarly interfaced to controller 124. In an embodiment using a wired interface, any of a number of appropriate signals are used for sending and or receiving signals to and/or from the attached devices. For example, a 0-10v control signal supplied to exhaust fan interface 134 from pressure and combustion controller 124 may control the speed of the variable speed motor, while a simple high/low signal may be transmitted to an appliance for the purpose of signaling the activation or deactivation of the appliance.

Although embodiments having wired connections between the input/output devices provide exceptional reliability, embodiments using wireless interfaces are advantageous for simplifying installation. Accordingly, in some embodiments, the connections between pressure and combustion controller 124 and any associated remote devices (e.g. differential transducer 126, pressure sensor 128, pressure sensor 130, intake fan interface 132, exhaust fan interface 134, and appliance interfaces 136) may include any number of wireless connections capable of providing appropriate signals between the respective remote device and pressure and combustion controller 124.

One such popular wireless protocol and transceiver is based the Z-Wave™ system offered by Zensys, Inc. of Upper Saddle River, N.J., the protocol of which is described in U.S. Pat. No. 6,879,806, which is hereby incorporated by reference in its entirety. Another such wireless standard, including a suitable protocol and transceiver, is the Zigbee™ protocol based on the Institute of Electrical and Electronics Engineers (IEEE) 802.15 standard, which is also incorporated by reference in its entirety.

In embodiments using wireless interfaces, each of controller 124 and any associated remote devices (e.g. differential transducer 126, pressure sensor 128, pressure sensor 130, intake fan interface 132, exhaust fan interface 134, and appliance interfaces 136) may be outfitted with an appropriate electronic transceiver. Each transceiver may be uniquely addressed and the transceiver associated with controller 124 is programmed to be capable of uniquely identifying each input/output device by each device's unique address.

To increase communication reliability between the controller and the input/output devices, it may be desirable to associate more than one transceiver for each device in the case of failure of the transceiver. For example, in such an embodiment, if a destination transceiver did not transmit an acknowledgement, the sending transceiver may send the signal to a backup transceiver associated with the device. In some embodiments, as used in the Z-wave system, a number of repeaters and alternate routes may be used to provide reliable transmissions around dead zones and across long distances.

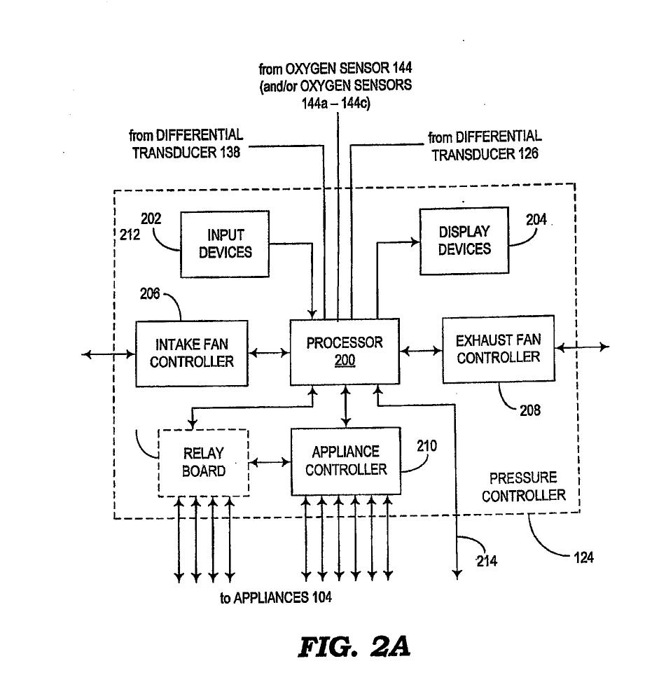

FIG. 2A is a block diagram of an embodiment of the pressure and combustion controller 124 shown in FIG. 1. In this embodiment, the pressure and combustion controller 124 includes a processor 200, such as a microprocessor or the like. The processor 200 preferably contains electrically erasable programmable read only memory (EEPROM) or other suitable memory device for storing settings and parameters established during set-up of the mechanical draft system 100. When the processor 200 is configured with a memory device such as EEPROM, an advantage can be realized in that the software of the processor 200 can be upgraded in the field during set-up or during normal system operation to include new controller functions for controlling mechanical draft systems.

The pressure and combustion controller 124 of FIG. 2A contains input devices 202 for receiving inputs from an installer, programmer, and/or technician. The input devices 202 may be configured as input buttons, keypads, keyboards, or other suitable input mechanisms. The pressure and combustion controller 124 also contains display devices 204, such as liquid crystal display (LCD) and light emitting diode (LED) components, for displaying various information about the condition of the mechanical draft system 100. For example, the display devices 204 may show the differential pressure, actual pressure in the mechanical room 102, alarm conditions, etc., and may indicate whether or not the intake fan 106 and exhaust fan 122 are functioning properly. The display devices 204 may also show information as it is being entered in the input devices 202.

The input devices 202 may include means for overriding automatic control of the processor 200 and for allowing manual control. During set-up of the mechanical draft system 100, the input devices 202 may be used for entering various information. For example, during set-up, the maximum and minimum fan speeds may be entered. Also, an input may be entered notifying the processor 200 how many appliances 104 are to be connected in the mechanical draft system 100. Also, with a plurality of appliances 104 in the system, priority information can be entered to establish a priority list dictating which appliances 104 should be allowed to run during a condition in which the exhaust fan 122 is malfunctioning or when the exhaust fan 122 has reached its maximum speed and cannot provide adequate draft. This priority mode is described in more detail below.

The pressure and combustion controller 124 further includes an intake fan controller 206 and an exhaust fan controller 208. The intake fan controller 206 receives information from the intake fan interface 132 (FIG. 1) for analysis by the processor 200. When the processor 200 detects a differential pressure that exceeds a predetermined threshold, the processor 200 may increase, decrease, or shut off the intake fan 106 via the intake fan controller 206. If the intake fan 106 is a single-phase fan, the intake fan controller 206 may contain a triac board, which may be configured to supply a 10-volt signal to the intake fan 106. Likewise, the exhaust fan controller 208 receives information from the exhaust fan interface 134 and adjusts the speed of the exhaust fan 122. The exhaust fan controller 208 may also contain a triac board if necessary. If one or the other fan is not connected to the mechanical draft system 100, the pressure and combustion controller 124 bypasses the respective controller 206 and 208 and compensates for the absence of the fan.

FIG. 2A further illustrates the pressure and combustion controller 124 having an appliance controller 210 that can shut down or restart the appliances 104 when necessary. The appliance controller 210 includes six outputs for controlling up to six appliances 104. The appliance controller 210 may also control the position of the dampers 110 located at the exhaust ducts 108 of each appliance 104 and/or the position of the modulating damper 113. In this regard, the position of the dampers 110 and 113 may be completely open, completely closed, or adjusted to a desirable intermediate position.

The pressure and combustion controller 124 may optionally contain a relay board 212 when more than six appliances 104 are connected in the mechanical draft system 100. The relay board 212 includes four terminals shutting down or restarting four additional appliances 104, thereby increasing the possible number of appliances that can be controlled by the pressure and combustion controller 124 up to ten. The pressure and combustion controller 124 further includes one or more external communication links 214. The external communication links 214 may also include connections to one or more external relay boards (not shown) when more than ten appliances are installed in the mechanical draft system 100. The external relay boards may be incorporated within relay boxes (not shown) that can be connected in a daisy chain fashion. Using the relay boxes, the pressure and combustion controller 124 may be configured to control an unlimited number of appliances 104.

External communication links 214 may also include an RS-232 (serial) port, RJ-45 (Ethernet) port, wireless port (e.g. IEEE 802.11), or RJ-11 (telephone) port for communicating with other auxiliary computing devices or peripherals capable of providing supplementary services. For example, such computing devices may include a computer used in a building management system.

FIG. 2B depicts a block diagram of an exemplary auxiliary computing device 216 capable of providing a number of supplemental services to pressure and combustion controller 124. Although auxiliary computing device 216 may essentially be physically located local to the controller itself, in some embodiments the computing devices may be located remotely, such as in a corporate data center, for example. Indeed, the functional and physical features of auxiliary computing device 216 could be integrated into pressure and combustion controller 214.

Regardless of the physical location, auxiliary computing device 216 may perform a number of supplementary functions such as providing alarm notification, data logging, and remote access and control to pressure and combustion controller 124. Auxiliary computing device 216 may also supply software updates over communication link 214 for reprogramming the processor 200 in the field according to any mechanical draft system pressure control advances that may be developed in the future.

Generally speaking, auxiliary computing device 216 may be one of a wide variety of wired and/or wireless computing devices, such as a laptop computer, PDA, handheld or pen based computer, desktop computer, dedicated server computer, multiprocessor computing device, cellular telephone, embedded appliance and so forth. Irrespective of its specific arrangement, portable computer system 28 can, for instance, comprise a bus 218 which may connect a processing device 222, memory 224, and an input/output interface 220. Although not depicted, it should be understood that auxiliary computing device 216 may also include a number of other computing devices such as, but not limited to, a display, user input devices, and/or a network interface.

According to some embodiments, processing device 222 can include any custom made or commercially available processor, a central processing unit (CPU) or an auxiliary processor, among several processors associated with the auxiliary computing device 216, a semiconductor based microprocessor (in the form of a microchip), a macroprocessor, one or more application specific integrated circuits (ASICs), a plurality of suitably configured digital logic gates, and other well known electrical configurations comprising discrete elements both individually, and in various combinations, to coordinate the overall operation of the computing system.

According to some embodiments, input/output interfaces 220 provide any number of interfaces for the input and output of data. For example, where the auxiliary computing device 216 comprises a personal computer, these components may interface with a user input device (not shown), which may be a keyboard or a mouse. Where the auxiliary computing device 216 comprises a handheld device (e.g., PDA, mobile telephone, etc.), these components may interface with function keys or buttons, a touch sensitive screen, a stylus, etc. Input/output interfaces 220 may also provide the capability to send and receive data from other computing devices (including pressure and combustion controller 124) and receive data and/or signals from measurement devices (e.g. sensors, etc.).

Memory can include any one of a combination of volatile memory elements (e.g., random-access memory (RAM, such as DRAM, and SRAM, etc.)) and nonvolatile memory elements (e.g., ROM, hard drive, tape, CDROM, etc.). The memory typically comprises a native operating system, one or more native applications, emulation systems, or emulated applications for any of a variety of operating systems and/or emulated hardware platforms, emulated operating systems, etc.

With respect to data logging, pressure and combustion controller 124 may be configured to send any available operational data to auxiliary computing device 216 over communication link 214. Auxiliary computing device 216 may be configured to receive and store the data within memory 224. For example, the data may be stored and arranged within a database or within logs which may be accessed for a number of purposes such as troubleshooting and providing reports and statistics. For example, such reports could be used for the purpose of providing government required emissions data. Customized reports may be generated to view statistics related to the control system, the appliances, and the building itself. These reports may, for example, assist an owner in determining available performance capacity of the appliances, usage trends, and the prediction of system failures.

In some embodiments, in addition to receiving operational data available to pressure and combustion controller 124 over communication link 214, the computing devices may be configured to receive any number of other inputs from sensors or building control systems through input/output interface 220. For example, measurement devices external to the auxiliary computing device 216 and/or a building control system may supply auxiliary computing device 216 with the temperature or humidity of the mechanical room 102 as well as the status of any other building system alarms (e.g. fire alarms, etc.).

In some embodiments, data received by auxiliary computing device 216 may include data recorded on a periodic basis or may record instances of measured values that have exceeded a specified range. For example, the types of operational data recorded on a periodic basis may include, but is not limited to: the draft, current used by fans 106 and/or 122, thermal data related to fans 106 and 122, the positions of dampers 110, the pressure differential between pressure sensors 128 and 130, the pressure differential between pressure sensors 140 and 142, the amount of oxygen detected by oxygen sensors 144/144a-144c, the on/off status of appliances 104, any alarms occurring on the controller or appliances. Auxiliary computing device 216 may be configured to monitor received data in real time and log an event occurrence if predetermined settings are tripped. For example, if the pressure differential exceeds a threshold value for more than thirty seconds, an occurrence may be logged by auxiliary computing device 216.

In some embodiments, operational data received by auxiliary computing device 216 may be used for real-time notification, interdiction, and/or control. For example, auxiliary computing device 216 may be configured to notify personnel via email, phone, pager, system alarms, visible lights, etc. upon the occurrence of a specified event. Statistical information can be kept which can be used to predict system performance, including system failure. By monitoring this data, system failures can be predicted before they occur, providing for the ability to schedule needed maintenance or down time.

In some embodiments, in addition to merely receiving data for analysis and storage, auxiliary computing device 216 may be further configured to provide feedback to pressure and combustion controller 124 for the purpose of controlling appliances, fans, dampers, etc. For example, nitrogen oxide (NOx) readings provided by an optional NOx particle sensor may be collected by auxiliary computing device 216. Because the draft of the exhaust system can effect the amount of NOx particles emitted from the system, the data may be used by pressure and combustion controller 124 to start or shut down appliances and/or adjust fan speeds and/or damper positions to keep NOx levels within predefined thresholds.

In some embodiments, auxiliary computing device 216 may also provide remote access to pressure and combustion controller 124 for ease in performing a number of administrative functions. For example, auxiliary computing device 216 may provide such access through RS-232 (e.g. Hyperterminal), through a dial-up modem, or over a network such as the Internet. Such a feature is advantageous in that it can provide ease in the configuration and use of the controller without the need for an extensive user interface (e.g. display, keyboard, and/or touch-screen) associated with pressure and combustion controller 124 itself.

In some embodiments, the remote access feature may provide the capability to configure alarm set points, view and download any logged data, create reports, view real-time data, and customize any configurable aspect of the controller (e.g. control and alarm set points, alarm text, appliance configuration, etc.) In the case that the auxiliary computing device 216 provides such access from remote locations (e.g. via the Internet or via dial-up access), the feature may be helpful for troubleshooting and configuration by expert personnel located remote from the actual controller. Such a feature can used by the vendor to provide real-time, remote troubleshooting and configuration assistance, or could be used by the user of the control system to provide remote troubleshooting where physical access to the pressure and combustion controller 124 is controlled and/or difficult. By providing remote access, the physical controller location may be selected with less emphasis on the ability for physical access.

In some embodiments, in addition to providing remote access to pressure and combustion controller 124, remote access to any auxiliary computing devices 216 may be provided to view and/or download logged data and/or reports. Accordingly, in addition to a user having direct access to pressure and combustion controller 124, access from other computing devices may be provided through auxiliary computing device 216.

In some embodiments, the pressure and combustion controller 124 shown in FIG. 2A, the processor 200 can perform a number of functions that have not been performed in previous exhaust systems and mechanical draft systems. For example, typical exhaust system processors may control either an intake fan or an exhaust fan, but usually do not control both intake fans and exhaust fans. Furthermore, typical exhaust system processors are not capable of controlling up to six appliances as is possible with the processor 200. The expandability of the system to manage an unlimited number of appliances with one processor is also an advantage that the processor 200 has over typical processors. In additional to these advantages, the processor 200 can perform other functions as well, as is explained below.

When a three-phase fan is installed in the mechanical draft system 100, the processor 200 may include an option to run the mechanical draft system 100 in a rotation check mode, which involves powering three-phase intake and/or exhaust fans at a low level when the fans are first installed. Since the direction of fan rotation is difficult to observe when a fan is rotating at typical operating speeds, sometimes creating a strobe effect that increases the difficulty, installers can benefit from the rotation check mode to avoid mistakenly determining fan rotation.

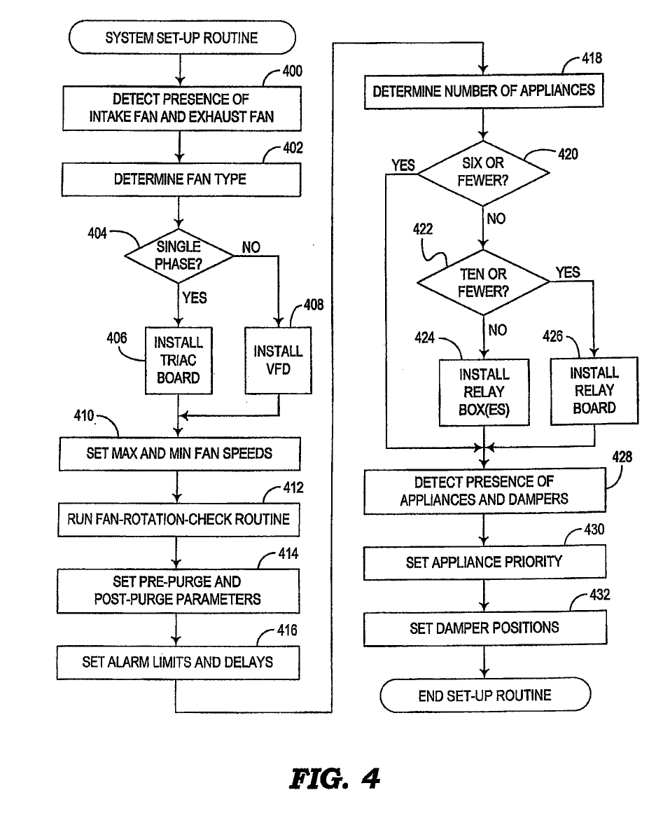

When a specific fan-intake-check input is received by the input devices 202, the input devices 202 signal the processor 200 to run the rotation check mode. In the rotation check mode, the processor 200 signals the intake fan controller 206 and/or the exhaust fan controller 208 to provide a low power signal to the respective fans. With low power applied thereto, the fans will rotate at a very slow speed, which may not be particularly useful for moving air but can clearly demonstrate to an observer the direction of rotation of the fan. The installer can observe the rotation of the newly installed fan in the rotation check mode to see whether or not the fan is rotating in the correct direction. If not, then it will be known that the terminals from the power source to the three-phase fan have been reversed. If reversed, the installer can correct the power connections so that the fan will rotate in the correct direction to force air appropriately. FIG. 5 illustrates an embodiment for checking fan rotation and is described in more detail below.

The processor 200 may also contain a memory device for storing a priority list that may be entered during the set-up of the mechanical draft system 100. Utilizing the priority list, the processor 200 can run a priority control procedure during less than optimal operating conditions. For instance, when the exhaust fan 122 is malfunctioning, or if it has reached its maximum speed and cannot provide sufficient draft to relieve a pressure build-up in the chimney 118 or mechanical room 102, then the priority control procedure is performed.

When one of the above conditions is detected, the priority control procedure is initiated. First, the processor 200 shuts down all the appliances via the appliance controller 210, the relay board 212, and/or the external communication link 214 and relay boxes. The processor 200 continues to check the differential pressure periodically and starts up the first appliance on the priority list. If a natural draft can be maintained with the one appliance added, then a second and subsequent appliances can be added until the differential pressure becomes unacceptable. At this level, the last added appliance is shut off to keep the pressure within acceptable tolerances. Additionally, the processor 200 continues to check the condition of the exhaust fan 122 to determine when it can operate properly again. Once the exhaust fan 122 is determined to be functional, the processor 200 resets or restarts the appliances 104 to their previous operating condition by signals through the appliance controller 210, relay board 212, and/or relay boxes.

The processor 200 may additionally be configured, based on installation instructions, to run in a continuous mode. In the continuous mode, the fans run continuously, even when the appliances 104 are shut down. When the appliances are running, the fans may be set to any level up to their maximum levels. When the appliances are off, the fans may be set to their minimum speed level.

Alternative to the continuous mode, the processor 200 may be configured to shut the fans off during periods of appliance inactivity. In this discontinuous mode, the processor 200 may initiate a pre-purge mode and/or a post-purge mode during transition periods between an appliance on-state and an appliance off-state. In this mode, when the appliances are off and a request for appliance operation is made, the processor 200 initiates the pre-purge mode in which the fans are turned on for a predetermined time before the appliances are actually fired. When the appliances are on and a request is made to shut the appliances off, the processor 200 shuts the appliances down and allows the fans to continue running for a predetermined time. During set-up of the mechanical draft system 100, an installer may input parameters concerning the minimum and maximum speeds of the fans, whether the system will run in a continuous mode or a discontinuous mode, pre-purge and post-purge parameters (when in the discontinuous mode), etc.

Furthermore, the processor 200 may be configured to maintain an error log of errors detected in the mechanical draft system 100. For instance, when a fan is indicated as being faulty, the processor 200 may save a record of the time and duration that the fan is out of service. The processor 200 may also indicate errors by a warning or alarm signal on the display devices 204. The tolerances within which the mechanical draft system 100 operates can be entered during system set-up, thereby determining the criteria by which the processor 200 detects errors, indicates alarm conditions, and/or controls fans and appliances.

Another feature that the processor 200 may possess is a procedure for running the fans in a discontinuous mode during long periods of inactivity, referred to herein as a bearing cycle. The bearing cycle runs the fans when they have not been running for a long time in order to work the bearings of the fans and to help lubricate the fans, thereby potentially extending the life span of the fans. The bearing cycle involves timing the periods of system inactivity with a timing device (not shown), such as, for example, a timer or clock within the processor 200. The processor 200 continuously monitors whether or not the appliances are operating and determines continuous stretches of time when the appliances are off. When the timing device determines that a predetermined period of inactivity has elapsed, the processor 200 signals the intake fan controller 206 and exhaust fan controller 208 to run the fans at a low speed for a short amount of time. The timing device is reset whenever the appliances are turned on or whenever the bearing cycle completes. This bearing cycle may then be repeated intermittently when needed.

In addition to features such as the described bearing cycle subroutine, processor 200 may also provide the ability to sequence the activation or deactivation of appliances 104. The general concept of appliance sequencing has been practiced for a number of years, and the advantages of appliance sequencing are well known. However, until now, such sequencing features have not been advantageously integrated with a pressure control system, enabling a number of improvements over prior art systems. A number of exemplary sequencing approaches are described in U.S. Pat. Nos. 3,387,589; 4,598,668; 4,860,696 and 5,042,431, each of which are hereby incorporated by reference.

Generally, the total demand of a multiple appliance system may be divided up among two or more appliances and the number, identity, and/or output setting of the appliances that are fired to meet this demand at particular time can be controlled through the sequencing feature of processor 200. For example, in a multiple boiler system only the boilers that are needed to closely match the heating load at any given time are fired. The output of each individual boiler may also be modulated to operate at some fraction of the boiler's total capacity. Controlling the number of boilers and their output may advantageously cause boilers that are being fired to continuously operate for longer periods of time. This is advantageous because, for a number of reasons, the efficiency of an appliance may increase by extending the period of time the appliances operate continuously, much like the average miles per gallon of a car increases when most of the driving is highway mileage rather than stop-and-go driving. Additionally, the efficiency of an appliance may change depending on the fraction of the boiler's total capacity being used. Accordingly, processor 200 can be preprogrammed to operate the proper number of boilers at their most efficient settings based on the total system demand.

Processor 200 may also take a number of other factors into account in selecting which appliances to operate (and at what capacity) under the specified conditions to meet an exhaust system objective. For example, processor 200 may be programmed to operate each appliance for a substantially equal time over an extended time period, thereby providing an equal distribution of the use of the appliances 104. However, in other situations, it may be advantageous to prioritize the use (or non-use) of an appliance having desired characteristics for a particular situation. For example, one appliance may be able to heat water more quickly at the expense of efficiency while other appliances may operate at a more desirable efficiency or environmental impact. Accordingly, processor 200 may be configured to sequence the appliances based on an environmental condition, appliance usage, appliance characteristic, fuel costs, or other user-desired parameters to meet the exhaust system objective. Thus, it should be understood that the programmed sequence for appliance activation may change over time based on any number of desired factors.

According to one exemplary embodiment, assuming that adequate draft can be maintained, the controller may be configured to specify the number and/or identity of the available appliances to be activated or deactivated based on the needs of the system (e.g. a call for heat, or a release of an appliance). Notably, this feature is distinguished from the priority function described above, which may be used to prioritize the appliances activated in the event that inadequate draft can be maintained for a desired system need.

In one embodiment, a specified number of appliances may be sequentially activated based on predetermined conditions. For example, in the case that appliances 104 are boilers for heating a water tank, a first boiler may be activated when the water temperature in the tank drops five degrees below a set point. A second boiler may be activated when the temperature drops ten degrees below the set point. Likewise, a third boiler may be activated when the temperature drops fifteen degrees below the set point. Although temperature has been used as an example, any measurable condition and associated set points could be used. In some embodiments the condition for activating or deactivating an appliance could originate from an external source, such as a building management system.

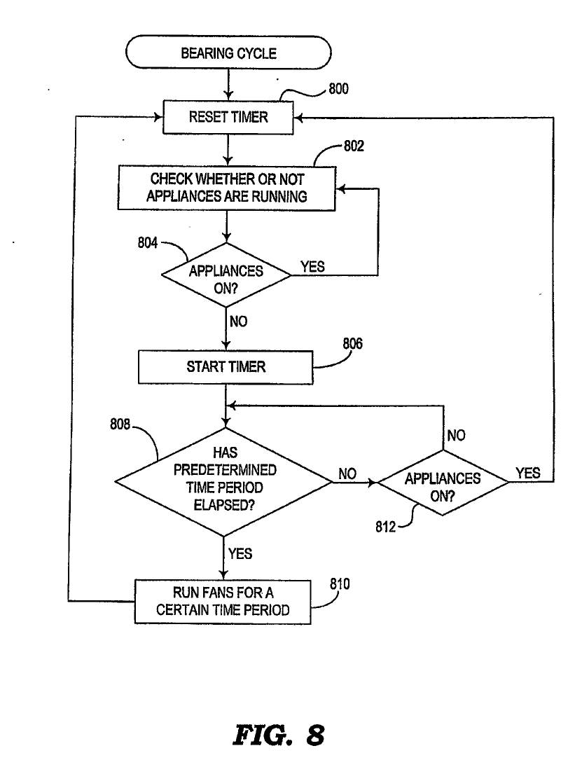

In addition to designating a number of appliances to be operational under the predetermined conditions, it is may also be advantageous for the sequencing function of processor 200 to identify the appliances 104 that are to be activated at a particular time. Although the programmable sequencing feature has been generally described, an exemplary sequencing subroutine is explained in more detail with respect to FIG. 9.

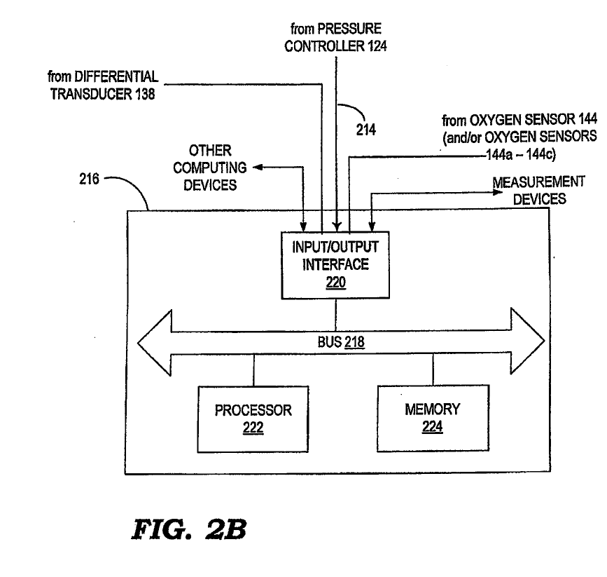

Looking now to FIG. 3A, a front view of an embodiment of a housing 300 that contains the pressure and combustion controller 124 is depicted. The front of the housing 300 includes a display screen 302, such as an LCD window, for showing information about the mechanical draft system 100. The housing 300 also includes program buttons 304 for entering system set-up parameters and for manually controlling the mechanical draft system 100. The program buttons 304, for instance, may include buttons for scrolling through options displayed on the display screen 302, buttons for proceeding through and selecting program functions, and buttons for setting or entering values. The housing 300 further includes LEDs 306 for visually indicating specific conditions of the mechanical draft system 100.

FIG. 3B is a bottom view of the embodiment of the housing 300. The bottom of the housing 300 includes ports 308 for connection to appliances, fans, differential transducers, etc. The housing 300 may also include a communication terminal 304 for connection to an external computer. For example, the communication terminal 310 may be an RS-232 port for communicating with a computer of a building management system. The communication terminal 310 may be used to receive program updates for re-programming or reconfiguring the processor 200 of the pressure and combustion controller 124. Furthermore, system parameters may be transmitted to an external computer via a communication network such as the Internet.

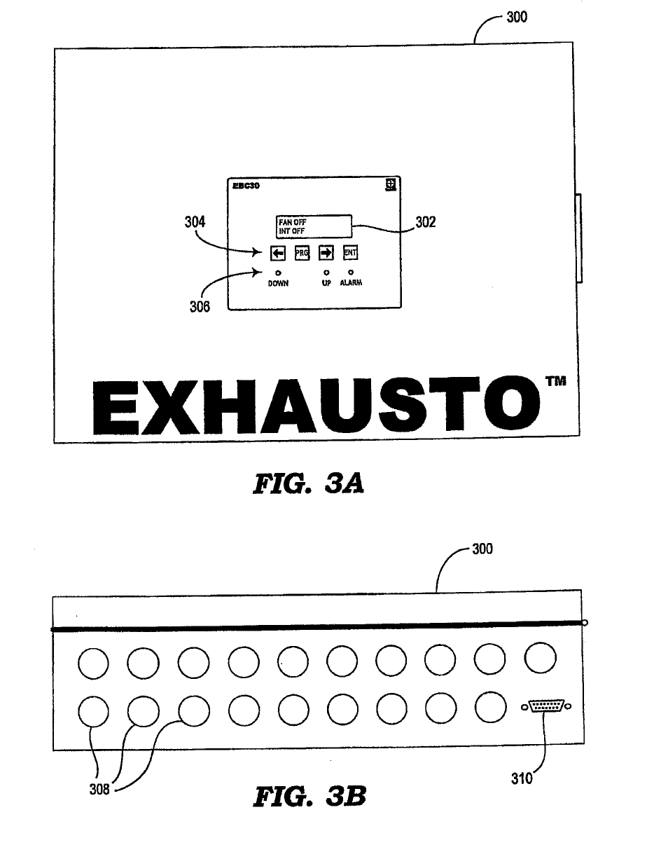

Methods of operating a mechanical draft system are now described with respect to FIGS. 4-8. These methods may include functions of a number of the elements described above with respect to FIGS. 1 and 2, including the pressure and combustion controller 124 and processor 200. Alternatively, the methods of FIGS. 4-8 may be incorporated as programs stored on the processor 200 or other suitable processor in a mechanical draft system.

FIG. 4 is a flow chart of an embodiment of a system set-up routine that may be performed when an exhaust system or mechanical draft system is being set up or installed in a building. Block 400 includes detecting the presence of an intake fan and an exhaust fan to determine what fans will be controlled during system operation. In block 402, the routine determines the types of fans that are present. In decision block 404, it is determined whether each fan is a single phase fan or a three phase fan. If a fan is a single phase fan, flow proceeds to block 406, in which the routine instructs or prompts the installer to install a triac board in a pressure and combustion controller so that the proper signal level may be delivered to the fan. If it is determined in decision block 404 that the fan is a three phase fan, then flow proceeds to block 408. In block 408, the routine instructs or prompts the installer to install a variable frequency driver (VFD) in the exhaust system or mechanical draft system so that three phase power signals may be delivered to the fan. It should be noted that blocks 404, 406, and 408 may be repeated for both the intake fan and exhaust fan.

The set-up routine of FIG. 4 next allows the installer to set maximum and minimum fan speeds for the intake fan and the exhaust fan, as indicated in block 410. These limits are set based on schematic and/or physical specifications and/or power capabilities of the respective fans. A minimum fan speed, or idling speed, is set when the mechanical draft system 100 is arranged for continuous use. If the system is configured in a mode where the fans are shut down when the appliances are not in use, referred to as a discontinuous mode, then block 410 may include setting the fan speeds during pre-purge and/or post-purge procedures.

In block 412, the system set-up routine may then run a routine for checking the rotation of three-phase fans to ensure that the power terminals connected to the fans are not wired incorrectly thereby resulting in a fan rotating the wrong way. One embodiment of the fan-rotation-check routine is described in more detail below with respect to FIG. 5. Block 414 includes setting pre-purge and post-purge parameters, such as the length of time that the fans will run after a call for heat has been requested and the length of time that the fans will run after the appliances are turned off. In block 416, the installer is prompted to input information to set alarm limits and delays according to user preferences and/or system design.

In block 418, the number of appliances to be connected in the exhaust system is determined. In decision block 420, it is determined whether or not the number of appliances is six or fewer. If so, then the pressure and combustion controller does not need to be altered in any way, since it is capable of handling this number of appliances without additional circuitry, and the routine proceeds to block 428. If there are more than six appliances connected in the exhaust system, then flow proceeds to decision block 422, where it is determined whether or not there are ten or fewer appliances. If there are seven to ten appliances in the system, then flow proceeds to block 426 where the installer is instructed or prompted to install an optional relay board in the pressure and combustion controller. With the relay board, the pressure and combustion controller may be capable of controlling up to ten appliances. If it is determined in decision block 422 that more than ten appliances are connected in the exhaust system, then flow proceeds to block 424. In block 424, the installer is instructed or prompted to install at least one relay box external to the pressure and combustion controller and connect the relay box or boxes to the pressure and combustion controller in a daisy chain fashion if necessary. Each relay box allows up to six additional appliances to be controlled. An unlimited number of relay boxes may be connected to allow for controlling any number of a plurality of appliances.

In block 428, the set-up routine of FIG. 4 detects the presence of the appliances and dampers. In block 430, an appliance priority list is set. Typically, appliances high on the priority list are those appliances that are located closest to the vertical stack or chimney. Alternatively, the type of appliance (boiler versus water heater, for example) may dictate which appliances are higher on the priority list. Other priority factor may be considered as well, such as appliances that are larger, newer, or more critical. In block 432, the blade positions of adjustable dampers in the exhaust ducts from each appliance are set in order to adjust the draft from individual appliances. Typically, appliances located closer to a vertical stack or chimney experience greater draft. Therefore, the dampers connected to the appliances in these locations may be adjusted by more greatly restricting exhaust flow from the appliances to account for this phenomenon. Also, block 432 may further include setting the blade position of a modulating damper in ducts receiving the air from the exhaust ducts in order to adjust the draft from all appliances.

FIG. 5 is a flow chart of an embodiment of a fan-rotation-check routine. The rotation of three phase fans may be checked during set-up of the exhaust system or mechanical draft system in order to ensure that the fans are wired to the power source correctly. If the terminals from the power source are reversed, the fan will rotate in a direction opposite from the desired direction, causing the flow of air to be forced in an undesirable manner. When the pressure and combustion controller receives a signal to initiate the fan-rotation-check routine, then the procedure, such as the one shown in FIG. 5, is executed.

The procedure for checking the rotation of the fans includes connecting the fans to the power source, as indicated in block 500. After the connections are made, block 502 includes supplying a low power signal to the fans to cause the fans to rotate at a very slow speed. In block 504, the installer may visually inspect the fans to see the direction of rotation. In decision block 506, the installer determines whether or not the direction of rotation is correct. If not, then flow proceeds to block 508, which involves instructing or prompting the installer to change the power source connections leading to the fans. After changing the power terminals, the procedure may end or alternatively may return back to block 502 for rechecking. If it is determined in decision block 506 that the fans are rotating correctly, then the fan rotation check routine ends. Another advantage of running the fan-rotation-check routine during set-up is that the slower fan speeds are safer for the installers.

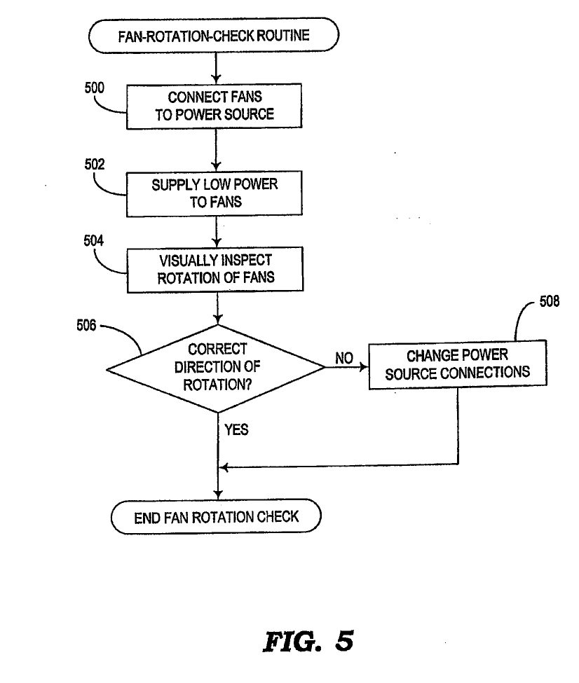

FIG. 6 is a flow chart illustrating an embodiment of a routine performed by the pressure and combustion controller after set-up and during normal operation of the exhaust system or mechanical draft system. Block 600 indicates that the differential pressure is checked intermittently and the operation of the fans is also checked. In decision block 602, it is determined whether or not the differential pressure is within an adequate range and whether or not the fans are operating properly. If so, the routine is directed to block 604 in which the speed of the fans is maintained. With the fan speeds maintained, flow returns to block 600 for intermittent checking. If it is determined in decision block 602 that the differential pressure exceeds a predetermined threshold or the fans are not operating acceptably, then flow proceeds to decision block 606.

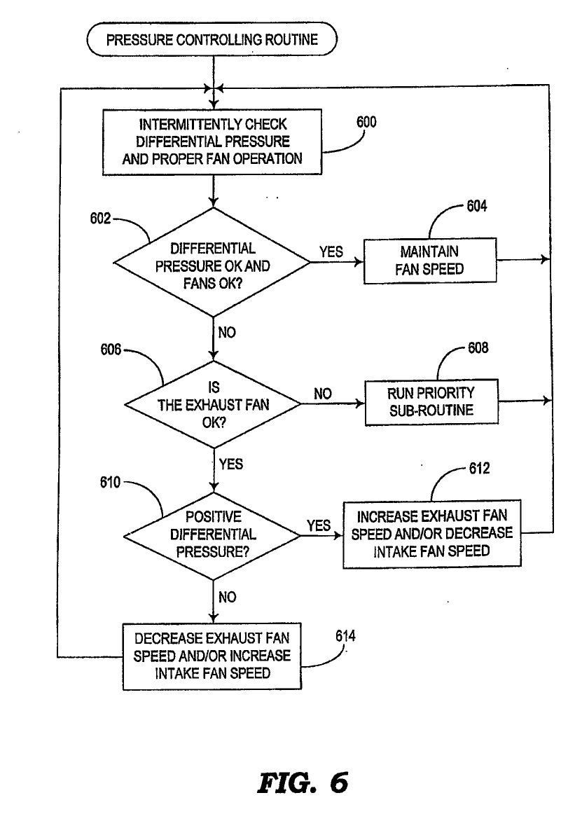

In decision block 606, the specific problem is identified by determining whether the exhaust fan is fine. If not, block 608 is conducted in which a priority sub-routine, such as the routine defined in FIG. 7, is run. Flow then returns to block 600 for continued monitoring. If the problem identified in block 606 is not the fans, then it is determined that the differential pressure is actually the problem. At this point, flow proceeds to decision block 610 for determining whether the out-of-range differential pressure is an excessive positive differential pressure or an excessive negative differential pressure. It should be noted that, in this embodiment, the pressure measured inside the mechanical room is connected to a negative terminal (or reference terminal) of a transducer and the pressure measured in the atmosphere is connected to a positive terminal of the transducer. However, the connections of the pressure measurements to the terminals of the transducer may be reversed if desired, and the proper response according to this routine is carried out.

If it is determined in block 610 that a positive differential pressure is present, thereby indicating that the pressure inside the mechanical room is significantly greater than the atmospheric pressure, then flow proceed to block 612. In block 612, the speed of the exhaust fan is increased and/or the speed of the intake fan is decreased in an attempt to equalize the pressure in the mechanical room. From this point, flow returns to block 600 for again intermittently monitoring the exhaust system. If it is determined in block 610 that a negative differential pressure exists, indicating a pressure inside the mechanical room significantly less than the atmospheric pressure, then the procedure flows to block 614. In block 614, the speed of the exhaust fan is decreased and/or the speed of the intake fan is increased. Furthermore, block 614 may include adjusting the dampers to more greatly restrict the exhaust from the individual appliances and/or from all appliances. The routine then returns to block 600 for continuous intermittent monitoring.

FIG. 7 is a flow chart illustrating an embodiment of a procedure for running a priority sub-routine in the situation when the differential pressure is determined to be outside of an acceptable range and the exhaust fan cannot provide adequate draft. Insufficient draft may be caused by the exhaust fan not operating properly or when the speed of the exhaust fan has reached its maximum speed and a request for a greater speed is called for. In such situations, the appliances are shut down, and a priority list, which is established during system set-up as described above, may then be used to establish which appliance is turned on first, provided that the chimney is capable of naturally exhausting air with an inadequate exhaust fan. If adequate draft can be maintain after restarting the first appliance on the priority list, then the second appliance on the list is turned on. This procedure is repeated until the greatest number of appliances has been turned on while a natural draft can be maintained in the chimney. Reference is now made to the flow chart of FIG. 7.

In block 700, when sufficient draft cannot be maintained and the differential pressure is outside acceptable levels, the appliances are shut down. In block 702, only the first appliance on the priority list is allowed to run. In block 704, after the appliance has run for a short amount of time, the differential pressure is checked again to determine if the chimney provides an adequate natural draft. In decision block 706, it is determined whether or not the differential pressure is within an acceptable range. If it is, the next appliance on the priority list is allowed to operate, as indicated in block 708, and flow returns to block 704 to recheck the differential pressure. Blocks 704, 706, and 708 are repeated until it is determined that the differential pressure is determined to be unacceptable in decision block 706. In this case, the appliance on the priority list that was added last is shut down, as indicated in block 710.

In decision block 712, the priority procedure determines if the exhaust fan is working. If not, then the differential pressure is checked again in decision block 714. As long as the pressure is determined to be fine, the appliances turned on in the exhaust system are allowed to run and the exhaust fan is checked until it is working again. If the pressure is determined to be unacceptable in block 714, the latest-added appliance on the priority list is turned off in block 710. Once it is determined that the exhaust fan is working in decision block 712, all of the appliances may be turned on, as indicated in block 716, and the priority sub-routine ends.

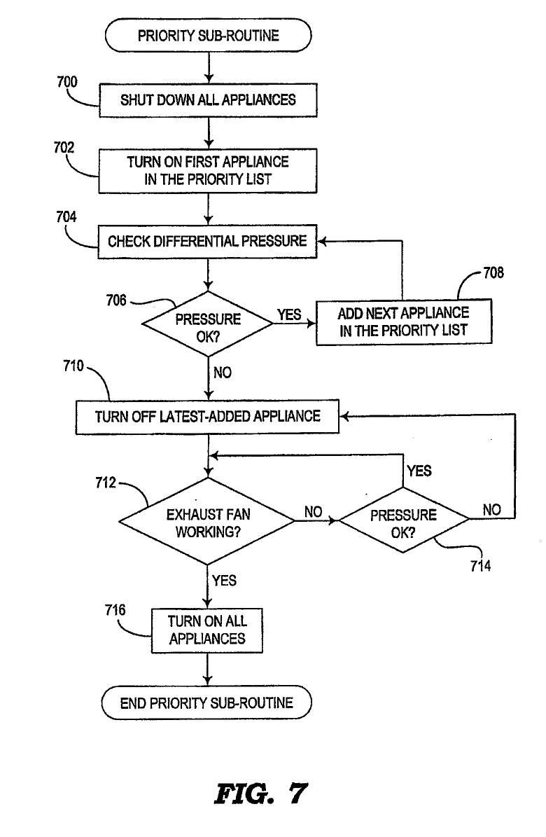

FIG. 8 is a flow chart illustrating an embodiment of a bearing cycle routine. A bearing cycle is a cycle of turning the fans on during periods of appliance inactivity. For instance, when heating appliances are not used for long periods of time, such as during warm summer months, the bearing cycle operates the fans for a predetermined amount of time, preferably at a low speed, such as 25% capacity, after a certain period of inactivity. The bearing cycle thus works the bearings of the fans in order to keep the fans from becoming rusty or locking up.

The bearing cycle procedure contains block 800, which includes resetting a timer that is used to determine a continuous length of time that the appliances are not running. In block 802, the appliances are checked to determine whether or not they are running. In decision block 804, if the appliances are running, they are intermittently checked again in block 802 until they are shut down. When the appliances are shut down, the timer is started, as indicated in block 806, to time the length of inactivity. If it is determined in decision block 808 that a predetermined time period has elapsed, indicating an extended period of inactivity, then the fans are turned on for a certain amount of time, as indicated in block 810, to adequately work the bearings of the fans. If the predetermined time period has not elapsed in block 808, then flow proceeds to decision block 812 in which it is determined whether or not the appliances have been called back into service. If they are, then flow returns to block 800 to restart the timer and repeat the process. If the appliances remain off, then the timer continues to run until the predetermined time period has elapsed in block 808.

FIG. 9 depicts a flow chart of an embodiment of a sequencing subroutine 900 that may be used in conjunction with the described mechanical draft system. Such sequencing blocks may, for example, be executed by processor 200 of pressure and combustion controller 124. At block 902, a signal is received from a remote device which can be used for determining a change in an operating characteristic of the system. For example, such operating characteristics may be a change in total system demand, a change in emissions output, or a change in efficiency. For example, such a signal may be transmitted from a building management system, an appliance, a fan, or one or more sensors. The signal could, for example, be a pressure reading, a call for heat, an emissions reading, an equipment alarm, an equipment failure, a measurement of efficiency, or any other signal to the controller that indicates (or could be used to indicate) a change in the active number or identity of appliances is needed. Such a change could include an increase or decrease in the number of appliances, or a change in the identity of the operating appliances to meet one or more desired system objectives. In one embodiment, the desired system objective is meeting a total system demand. However, system objectives may vary and could be also be, for example, meeting a desired efficiency or emissions output, for example.

At step 904, it is determined whether the system operating characteristics have changed such that a different quantity or identity of appliances are needed to meet the objective based on the received signals. If the characteristics have not changed enough to warrant a change in the activated appliances (the NO condition), the signals are continuously monitored at block 902 until such a change occurs.

However, if the operating characteristics have changed (the YES condition), it is determined whether all available appliances are needed to satisfy the desired system objective at block 906. For example, the system may determine that all appliances should be activated to operate at the desired system efficiency or to meet a desired demand. If all available appliances in the system are required to meet the system objective (the YES condition), all of the appliances are activated through their communications interface with appliance controller 210 and/or relay board 212 of pressure and combustion controller 124. In this case, no further sequencing decisions are required.

However, if less than all of the available appliances are needed to meet the system objective (the NO condition), the sequencing algorithm may perform a number of sequencing decisions. For example, at block 910, the number of appliances needed to meet the indicated exhaust system objective is determined. In addition to determining the total appliances needed to meet the demand, this step may also include calculating how many appliances need to be activated or deactivated to reach the total. The step of determining the number of appliances needed to meet the objective may be programmable, and may, for example, be determined using collected data (e.g. from the received signal) and a look up table, a calculation, or one or more thresholds.

At block 912, the identity of the appliances to be activated or deactivated may also be determined based on programmable settings, appliance specifications, and/or historical appliance operational data. For example, the appliance identities may be advantageously selected to equalize their use over a period of time, increase efficiency, and/or increase performance. Accordingly, at block 914, the identified appliances are activated or deactivated are through their respective communications interface with appliance controller 210 and/or relay board 212 of pressure and combustion controller 124.

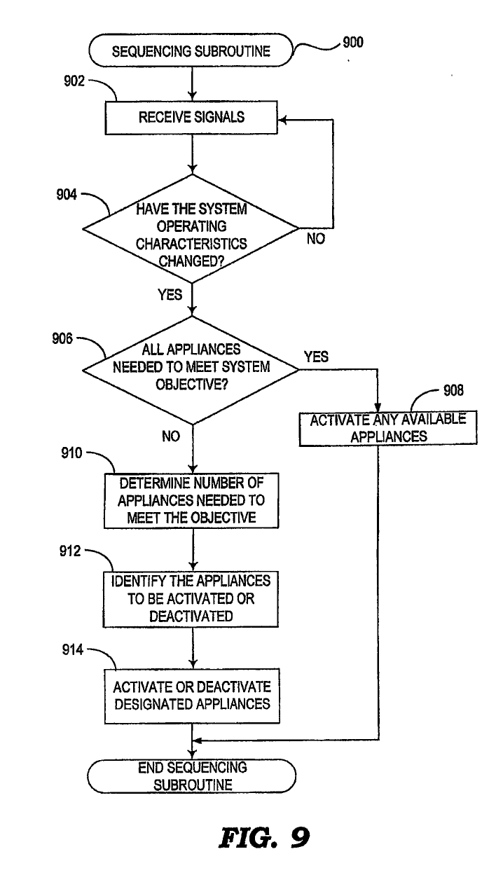

FIG. 10 depicts another embodiment of a mechanical draft system. Specifically, in this embodiment, mechanical draft system 1000 includes multiple fireplace appliances (e.g., fireplaces 1002 and 1004). Notably, such a system can be used in a variety of environments, such as with one or more of the fireplaces being located on various floors of a multi-floor complex, e.g., a commercial or residential building.

As shown in FIG. 10, system 1000 includes a chimney 1006 into which combustion products from the fireplaces are drawn by a chimney fan 1007. Typically, the chimney fan is set to idle speed until a request for heat is sensed. In this embodiment, the fireplaces are gas-based fireplaces, such as ISOKERN® fireplaces manufactured by Schiedel Isokern A/S Corporation Denmark.

Each of the fireplaces (e.g., fireplace 1004) is supplied with gas via a gas valve (e.g., gas valve 1008). On/off operation of the fireplace is facilitated by a control switch (e.g., switch 1010). In this embodiment, each control switch is located within a corresponding room such that independent, locally controlled ignition is provided for each of the fireplaces. As such, when the system is implemented in a residential building, for example, each of the control switches could be controlled by a different occupant of the building.

Actuation of the control switch opens a modulated damper (e.g., damper 1011). Specifically, the damper is positioned by an actuator of an actuator assembly (e.g., actuator assembly 1012). The actuator assembly also includes an end switch (not shown) that closes in response to the damper being in the open position. Closing of the end switch powers a thermal limit circuit (e.g., circuit 1013) of the associated fireplace burner (e.g., burner 1014). This causes a pilot of the burner to heat a corresponding thermocouple of the thermal limit circuit. Responsive to a signal from the thermocouple (which indicates that the pilot is lit), gas valve 1008 opens and initiates ignition of the fireplace. Notably, the thermal limit circuit prevents the fireplace from operating when the damper is closed.

A proven draft switch (e.g., switch 1016) monitors flow in an associated duct (e.g., duct 1017) that interconnects the fireplace with the chimney 1006. Based on the desired flow in the duct, which can be monitored by one or more flow probes (e.g., probes 1018, 1019), the position of the gas valve can be reset by the proven draft switch. For instance, if the minimum flow setting is not detected by the proven draft switch, the gas valve can be closed.

A system controller 1020 monitors pressure and/or flow parameters in the chimney 1006. In this embodiment, a pressure sensor including a transducer 1021 and a stack probe 1022 is used to provide inputs to the system controller. Specifically, signals indicative of pressure in the chimney are provided by the pressure sensor to the controller. Based on the sensed pressure, the controller can provide control signals to the chimney fan 1007 so that the chimney fan sets a desired pressure in the chimney.

Upon additional calls for heat, similar start sequences for others of the fireplaces can be undertaken. As each start sequence progresses, the controller modulates the speed of the chimney fan as needed to ensure that the desired pressure is maintained in the chimney. Notably, a constant negative pressure typically is desired in the chimney and the associated ducts.

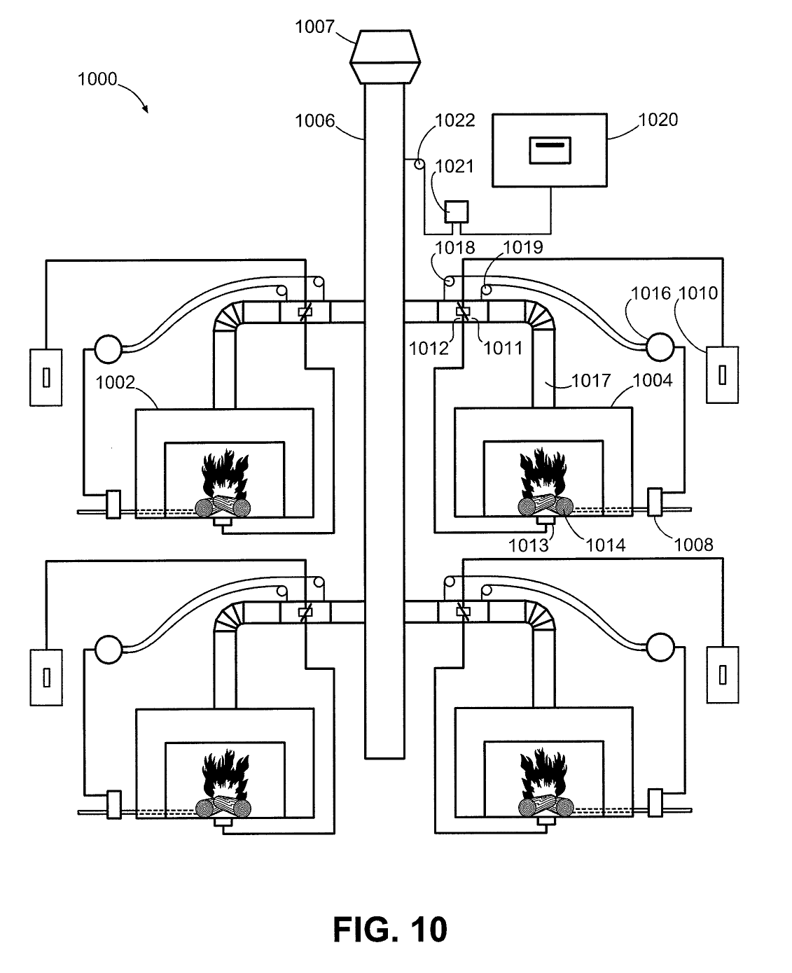

FIG. 11 depicts an embodiment of a fan assembly. Fan assembly 1100 can be used in various systems, such as a mechanical draft system that includes at least one appliance, such as a boiler, water heater or fireplace, for example.

In the embodiment of FIG. 11, fan assembly 1100 includes an inlet 1102, an outlet 1104 and a housing 1106 positioned between the inlet and outlet. The inlet includes an upstream opening 1108 and a downstream opening 1109, the housing includes an upstream opening 1110 and a downstream opening 1111, and the outlet includes an upstream opening 1112 and a downstream opening 1113. Notably, openings 1109 and 1110 communicate with each other to facilitate flows between the inlet and the housing, while openings 1111 and 1112 communicate with each other to facilitate flows between the housing and the outlet.

Housing 1106 is a linear-flow housing, meaning that the mean flow path through the housing is linear. The linear flow through the housing is attributable to the positioning of openings 1110 and 1111, which are located at opposing ends 1114 and 1115, respectively, of the housing.

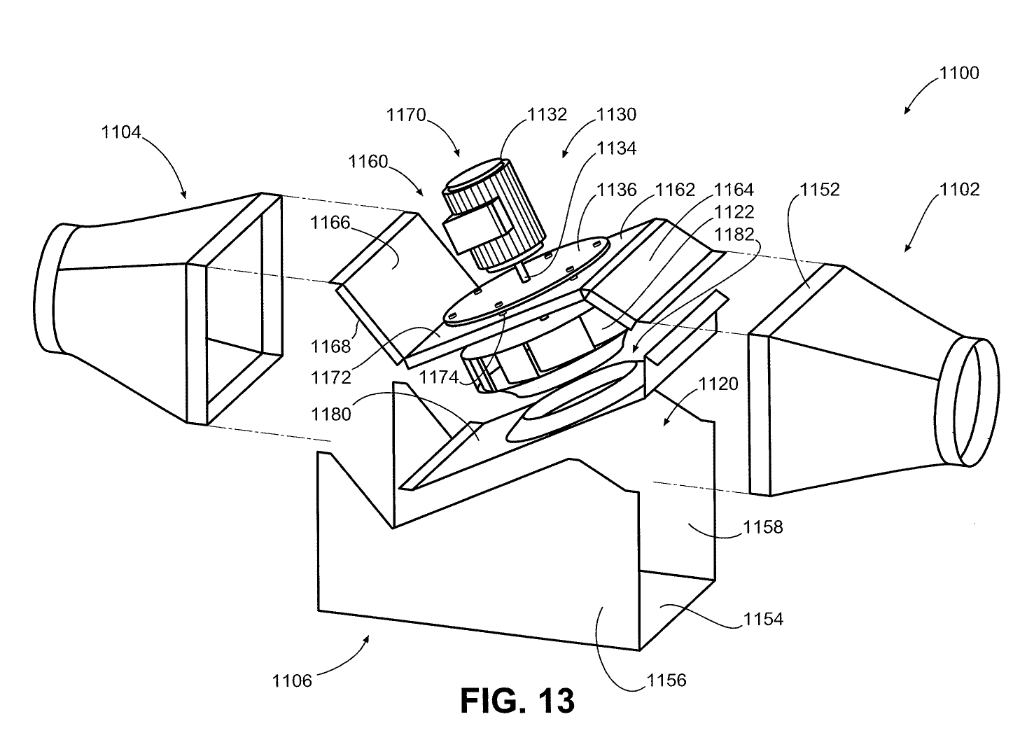

Housing 1106 defines an interior chamber 1120 within which an impeller 1122 of a centrifugal fan 1130 is positioned. In particular, the chamber 1120 is partitioned into an intake compartment 1123 and an exhaust compartment 1124. Fan 1130 additionally includes a motor 1132 and a drive shaft 1134 (FIG. 13). The motor is mounted to a cooling plate 1136 and is positioned external to the housing. Shaft 1134 extends from the motor to the impeller. In this embodiment, the axes (1135, 1137 and 1139) of rotation of the motor, the shaft and the impeller, respectively, are co-linear.

The axes of rotation are inclined with respect to the linear flow path defined by a line 1140 extending between the respective centers of openings 1110 and 1111 of the housing. The axes of rotation intersect line 1140, although an offset configuration can be used in other embodiments. Note also that, in this embodiment, the inlet and the outlet are aligned along extensions of the linear flow path (illustrated with dashed arrows) such that the inlet, the housing and the outlet are in an in-line configuration. This is in contrast to typical centrifugal fan installations that include inlets and outlets that are non-linear, owing primarily to the angular offset between the intake and exhaust of the impeller.

It is also noteworthy that fan assembly 1100 is depicted in FIG. 11 as being attached to a chimney 1150 in a substantially vertical orientation. Thus, in this embodiment, the openings of the inlet, the housing and the outlet are in-line with the vertical run of chimney 1150.

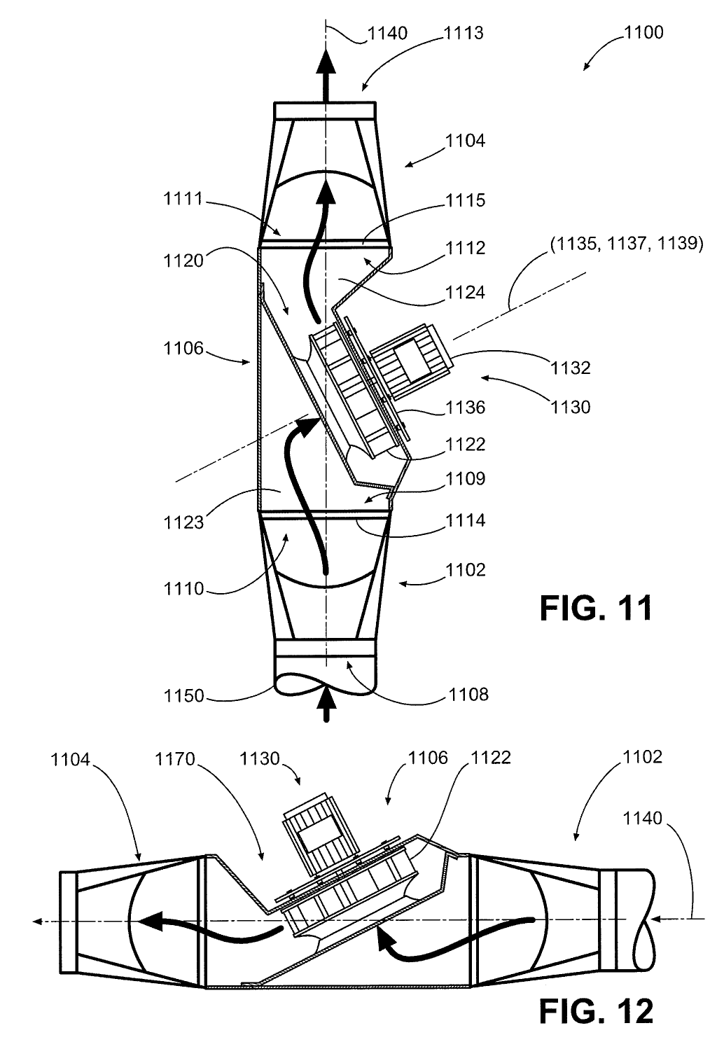

In contrast, FIG. 12 depicts the fan assembly 1100 installed in a horizontal orientation. In other installations, various other orientations can be used.

FIG. 13 is a partially-exploded view of the embodiment of FIGS. 11 and 12. As shown in FIG. 13, each of the inlet 1102 and outlet 1104 varies in cross-sectional area along its length. In this embodiment, each includes a rectangular slip-fitting (e.g., slip-fitting 1152) that mates with a corresponding end of the housing. Distal ends of the inlet and outlet are circular. In other embodiments, various other shapes and configurations (e.g., flange fittings) of inlets and outlets can be used. Notably, various diameters of inlets and/or outlets can be used with the same housing, thereby increasing the adaptability of the system.

The housing 1106 is formed of a base 1154 and sidewalls 1156, 1158 that extend upwardly from the base. Upper edges of the sidewalls are shaped to receive corresponding surfaces of a mount 1160, which is used to form a portion of the exterior of the housing and to position the fan. This results in a housing with a generally rectangular cross-section along its length. Various other shapes can be used in other embodiments.

In the embodiment of FIG. 13, the mount includes a planar intermediate portion 1162, which (in combination with the sidewalls) sets the angle of inclination of the impeller, and first and second end portions 1164, 1166 that extend from opposing ends of the intermediate portion. Flanges (e.g., flange 1168) are positioned about the periphery of the mount to facilitate attachment. The inclined aspect of the intermediate portion of the mount forms a recess 1170 in the exterior of the housing that receives the motor 1132. This profile tends to reduce the overall height of the assembly as the motor is at least partially recessed relative to the ends of the housing.

The shaft 1134 extends through a hole in the mount to facilitate positioning of the motor external to the chamber 1120. The cooling plate, through which the shaft also extends, is fastened to the exterior surface 1172 of the mount. Spacers (e.g., spacer 1174) are disposed between the mount and the cooling plate to provide a clearance between these components to enhance cooling. Cooling provisions such as the cooling plate may tend to extend bearing life.

Although not clearly visible, cooling fins extend from the cooling plate toward the housing. Various other cooling provisions can be used, such as by incorporating a cooling vane installed inside the housing on the motor shaft (e.g., above the impeller). Alternatively, a cooling vane can be an integral part of the impeller. In some of these embodiments, the fins are attached to the impeller and point upwards towards the motor.

A divider 1180 is positioned within the housing that partitions the chamber into an intake compartment and an exhaust compartment. The partition restricts gases flowing into the housing via the intake compartment from leaving the housing without flowing through the impeller 1122, which is located in the exhaust compartment. Notably, the divider includes a port 1182 with a contoured edge that directs gases to the inlet of the impeller. Although generally planar in this embodiment, various other shapes of dividers can be used.

Drainage can be facilitated in a number of ways. For instance, a hole can be provided at the low point of the housing. In other embodiments, a spout and hose configuration can be used, among others. Drainage also can be provided between the compartments, such as by providing a hole at the low point of the divider 1180. When installed in a vertical position, drainage in the divider allows condensate to flow from the outlet compartment to the inlet compartment from where it can run back into the chimney for drainage.

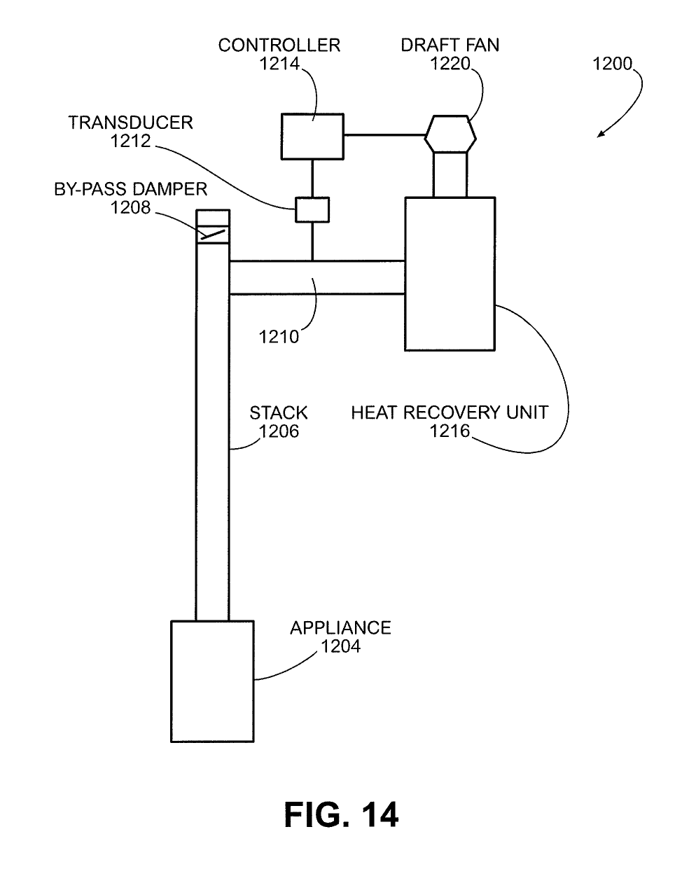

Some embodiments can incorporate a heat recovery system in order to recapture some of the exhaust heat for useful work. In this regard, FIG. 14 is a partial block diagram illustrating an embodiment of a mechanical draft system 1200 incorporating an embodiment of a heat recovery unit.

As shown in FIG. 14, draft system 1200 includes a representative appliance 1204 (e.g. a boiler), a chimney (or stack) 1206, a by-pass damper 1208, a by-pass duct 1210, a transducer 1212, a controller 1214, a heat recovery unit 1216 and a fan 1220. In this embodiment, the heat recovery unit is a direct-contact condensing flue gas heat recovery unit designed for natural gas or LP gas fired appliances, such as boilers, water heaters and process heaters.

In the heat recovery unit, hot flue gas is conveyed through a heat recovery tank where the sensible heat and latent heat are recovered using a water mist. A secondary heat exchanger (e.g., a brazed plate heat exchanger) is used to transfer the heat from the heat recovery tank to a heat sink. The heat sink can include a hot water tank, a radiator, a pre-heater etc. In some embodiments, the unit may be designed to reduce emissions either by using chemicals in the water mist or by other means.

During system operation, draft fan 1220 is controlled by controller 1214, which assures the fan operates at a proper speed that provides proper draft to the appliance(s) boiler and assures adequate flow through the heat recovery unit. By-pass damper 1208 is configured to open automatically in this embodiment should the draft fan or the heat recovery unit fail. This allows the appliance to exhaust without any excess resistance.

The flow charts of FIGS. 4-9 show the architecture, functionality, and operation of possible implementations of mechanical draft system control software. In this regard, each block represents a module, segment, or portion of code, which comprises one or more executable instructions for implementing the specified logical functions. It should also be noted that in some alternative implementations, the functions noted in the blocks may occur out of the order noted in the figures. For example, in the set-up routine of FIG. 4, two blocks shown in succession may in fact be executed substantially concurrently or the blocks may be executed in the reverse order, depending upon the specific functional programming involved.

The mechanical draft system control programs, which comprise an ordered listing of executable instructions for implementing logical functions, can be embodied in any computer-readable medium for use by an instruction execution system, apparatus, or device, such as the processor 200 (FIG. 2) or other suitable computer-based system, processor-controlled system, or other system that can fetch the instructions from the instruction execution system, apparatus, or device and execute the instructions. In the context of this document, a “computer-readable readable medium” can be any medium that can contain, store, communicate, propagate, or transport the program for use by the instruction execution system, apparatus, or device. The computer-readable medium can be, for example, an electronic, magnetic, optical, electromagnetic, infrared, or semiconductor system, apparatus, device. More specific examples of the computer-readable medium include the following: an electrical connection having one or more wires, a portable magnetic computer diskette, a random access memory (RAM), a read-only memory (ROM), an erasable programmable read-only memory (EPROM or Flash memory), an optical fiber, and a portable compact disc read-only memory (CDROM). In addition, the scope of the present disclosure includes the functionality of the herein-disclosed embodiments configured with logic in hardware and/or software mediums.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A mechanical draft system comprising:
a chimney operative to direct combustion products;
a chimney fan operative to draw combustion products from the chimney;
a first fireplace operative to provide combustion products to the chimney;
a second fireplace operative to provide combustion products to the chimney; and
a controller operative to adjust an operating speed of the chimney fan such that, responsive to a change in pressure in the chimney, the controller adjusts the operating speed of the chimney fan to maintain a desired pressure in the chimney.

2. The system of claim 1, further comprising:
a first duct interconnecting the first fireplace and the chimney; and
a first damper positioned within the first duct, the first damper being operative to move between an open position, at which the first fireplace is enabled to vent combustion products to the chimney, and a closed position, at which the first fireplace is prevented from operating.

3. The system of claim 2, further comprising:
a first control switch operative to initiate an ignition sequence of the first fireplace; and
an actuator assembly operative to position the first damper responsive, at least in part, to actuation of the first control switch.

4. The system of claim 3, wherein the actuator assembly has an actuator and an end switch, the actuator being operative to position the first damper, the end switch being operative to sense the open position of the first damper.

5. The system of claim 2, further comprising a burner and a thermocouple, the burner being operative to ignite a fire in the first fireplace, the thermocouple being operative to sense operation of the burner.

6. The system of claim 5, further comprising a gas valve operative to provide a flow of gas to the burner for combustion responsive to an indication that the thermocouple senses operation of the burner.

7. The system of claim 1, further comprising:
a first control switch operative to initiate an ignition sequence of the first fireplace; and
a second control switch operative to initiate an ignition sequence of the second fireplace.

8. The system of claim 1, further comprising a pressure sensor positioned in the chimney, the pressure sensor being operative to provide information corresponding to a sensed pressure within the chimney to the controller.

9. The system of claim 1, wherein the chimney fan is a single chimney fan of the system.

10. The system of claim 1, wherein the first appliance is a gas fireplace.

11. The system of claim 1, further comprising a heat recovery unit operative to extract heat from gasses in the chimney.

12. A mechanical draft system for use with multiple appliances comprising:
a chimney operative to direct combustion products from multiple appliances;
a chimney fan operative to draw combustion products from the chimney; and
a controller operative to adjust an operating speed of the chimney fan such that, responsive to a change in pressure in the chimney, the controller adjusts the operating speed of the chimney fan to maintain a desired pressure in the chimney.

13. The system of claim 11, further comprising the multiple appliances.

14. The system of claim 13, wherein:
a first of the multiple appliances is located on a floor of a structure; and
a second of the multiple appliances is located on another floor of the structure.

15. The system of claim 13, wherein the multiple appliances are gas fireplaces.

16. The system of claim 12, further comprising an exhaust fan assembly having an inlet, a housing, a centrifugal fan and an outlet;
the housing defining a chamber and having opposing openings;
the inlet, the openings and the outlet being arranged along a centerline;
the centrifugal fan having an impeller positioned within the chamber.

17. A method for controlling multiple appliances comprising:
providing multiple appliances, each of which is operative to facilitate independent, locally controlled ignition;
venting combustion products of the multiple appliances using a single chimney; and
controlling pressure in the chimney with a single chimney fan.

18. The method of claim 17, further comprising controlling the single chimney fan with a single controller.

19. The method of claim 17, wherein first and second ones of the multiple appliances are located on different floors of a building.

20. The method of claim 17, wherein the multiple appliances are gas fireplaces.

21. An exhaust fan assembly comprising:
a housing defining a chamber and having opposing openings, the opposing openings having a centerline extending therebetween, a first of the openings being operative to intake a flow of gases, a second of the openings being operative to exhaust the flow of gases from the chamber; and
a centrifugal fan having a motor and an impeller, the motor being mounted external to the housing, the impeller being positioned within the chamber, a rotational axis of the impeller being inclined with respect to the centerline extending between the openings of the housing.

22. The assembly of claim 21, further comprising:
an inlet operative to provide the flow of gases to the first of the openings; and
a outlet operative to receive the flow of gases from the second of the openings;
the inlet, the openings of the housing and the outlet being arranged in an in-line configuration.

23. The assembly of claim 21, wherein the rotational axis of the impeller intersects the centerline.

24. The assembly of claim 21, further comprising a cooling plate positioned between the motor and the exterior of the housing.

25. The assembly of claim 21, wherein the assembly further comprises a divider positioned within the housing and being operative to partition the chamber into an intake compartment, communicating with the first of the openings, and an exhaust compartment, communicating with the second of the openings, the partition being further operative to restrict gases from the intake chamber from leaving the housing without flowing through the impeller.

26. The assembly of claim 25, wherein the divider is inclined with respect to the centerline.
